(19) United States
(12) Patent Application Publication
(10) Pub. No.: US 2006/0155671 A1
(43) Pub. Date: Jul. 13, 2006

(54) Virtual protection service

(75) Inventors: David Fredrick Bantz, Portland, ME (US); Thomas E. Chefalas, Somers, NY (US); Steven J. Mastrianni, Unionville, CT (US); Clifford A. Pickover, Yorktown Heights, NY (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/035,349

(22) Filed: Jan. 13, 2005

(51) Int. Cl. G06F 7/00

(52) U.S. Cl. 707/1

(57) ABSTRACT

A method of transferring an image of a system or disk to a computer dedicated to performing a resource-intensive task, such as virus scanning, disk defragmentation or similar service. Once the dedicated computer has performed the task, the resulting image is compared to the current image of the client system or disk to produce an updated image. The client system or disk is then updated with the updated image.

### BACKGROUND OF THE INVENTION

1. Technical Field

The present invention relates to a system and method for providing a virtual protection service for a computing device or computer system.

2. Description of Related Art

Many programs supplied by vendors such as Microsoft Corporation, Symantec Corporation, and Lava Software Pty. Ltd. perform needed search tasks, security tasks or maintenance tasks. Search tasks include tasks such as file searching, text searching, string searching, and heuristic scans for arbitrary solutions. Security tasks include, for example, virus scanning, virus removal, and quarantine, removal of spyware, removal of adware, removal of browser helper objects, and removal other types of infections. Examples of maintenance tasks include disk defragmentation, physical disk checking, disk repair, data backup, file encryption, file decryption, file compression, and file decompression. All of these tools require significant resources such as CPU time and disk access in the target computer.

When any of these tools are running, the performance of the computer is often extremely poor, making the performance of other tasks difficult. For example, if a backup starts while a user is in the middle of editing a file that is critical for a presentation, the file could become unusable until the backup is finished. In some cases, the file will not be backed up because it is being used. Furthermore, one task may require another; for example, a backup of a file should be done after that file has been scanned for viruses. If the user is a skilled technician, the user can lower the execution priority of the application to free up more resources to other programs. While this may free up some CPU time or memory space, the modification often produces no noticeable results because the part of the operating system being checked may require significant system resources. Software such as device drivers and other operating system software are normally unaffected by priority changes, which have an effect only on user application software.

These conditions produce an undesirable work environment where the user can do little work because the system is too busy performing required search, security, and maintenance tasks. This problem is accentuated if regular maintenance has not been performed because security and maintenance tasks are frequently scheduled to run immediately the next time a device is activated. A user may need to accomplish a task quickly upon activating a computer, but may have to wait an unacceptable amount of time for the security or maintenance task to be completed. Therefore it would be advantageous to have an improved method, apparatus, and computer instructions for an improved tool that reduces use of computer resources.

### SUMMARY OF THE INVENTION

The methods and devices described below provide for a method of transferring part of all of an image of a system or disk to another computer dedicated to performing a resource-intensive task, such as search tasks, security tasks, maintenance tasks or any other resource-intensive tasks. Once the dedicated computer has performed the task, the resulting image is compared to the current image of the client system or disk. The two images are integrated or synchronized to produce an updated image. The client system or disk is then updated with the updated image. Thus, the invention solves the problem caused by a search, security or maintenance task consuming too much of a computer's resources.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented.

FIG. 2 is a block diagram of a data processing system that may be implemented as a server, such as server 104 in FIG. 1.

FIG. 3 is a block diagram illustrating a data processing system in which the present invention may be implemented.

FIG. 4 is a flow chart illustrating a method in accordance with a preferred embodiment of the invention.

FIG. 5 shows a block diagram of software configuration of components, in accordance with a preferred embodiment of the invention.

FIG. 6 is a flow chart of a process used by a detector component, such as the detector component of FIG. 5, in accordance with a preferred embodiment of the invention.

FIG. 7 is a flow chart of a process performed in the site determination component of FIG. 5, in accordance with a preferred embodiment of the invention.

FIG. 8 is a flow chart of a process performed during the analyze resource availability step of FIG. 7, in accordance with a preferred embodiment of the invention.

FIG. 9 is a flow chart of a process performed in the task-scheduling component of FIG. 5, in accordance with a preferred embodiment of the invention.

FIG. 10 is a flow chart of a process performed in the task supervisor component of FIG. 5, in accordance with a preferred embodiment of the invention.

### DETAILED DESCRIPTION OF THE PREFERRED EMBODIMENT

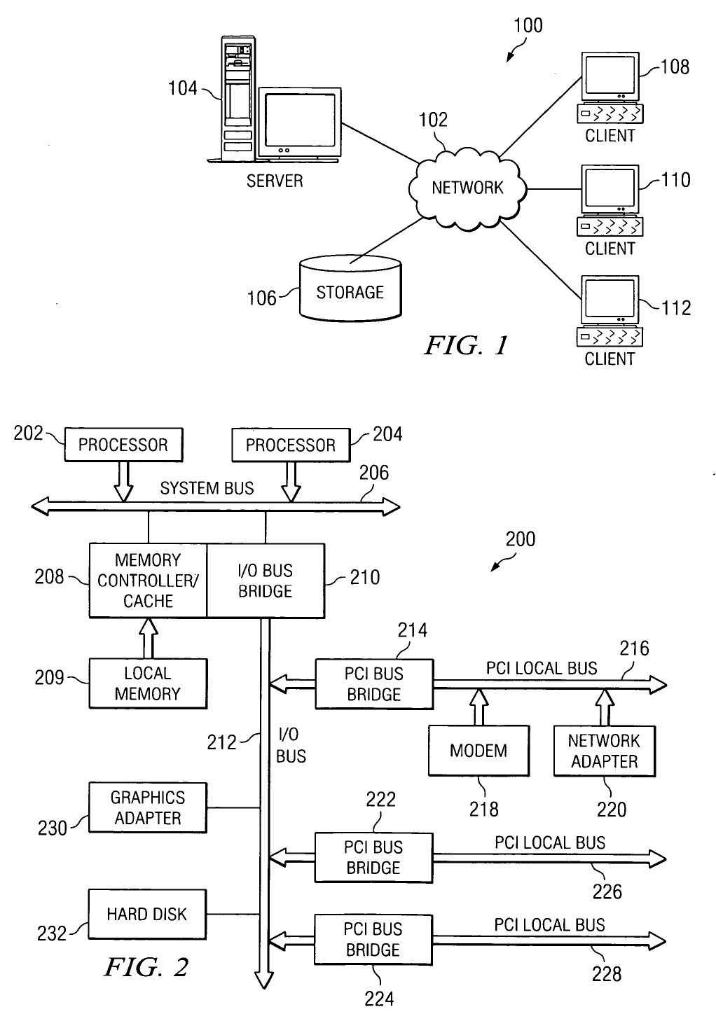

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

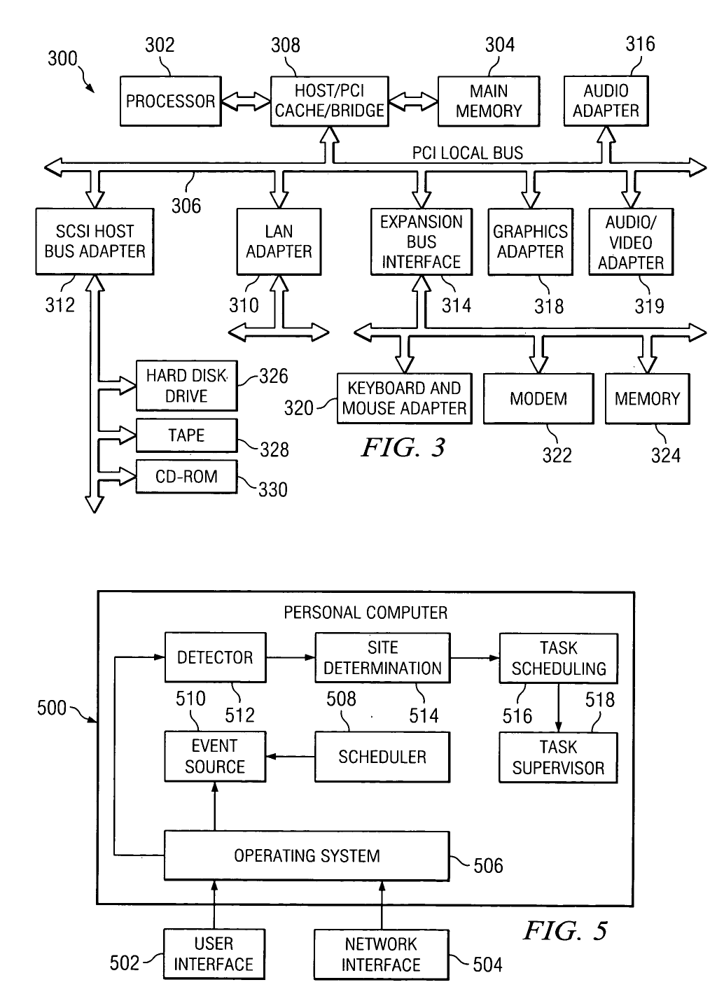

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. In addition, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

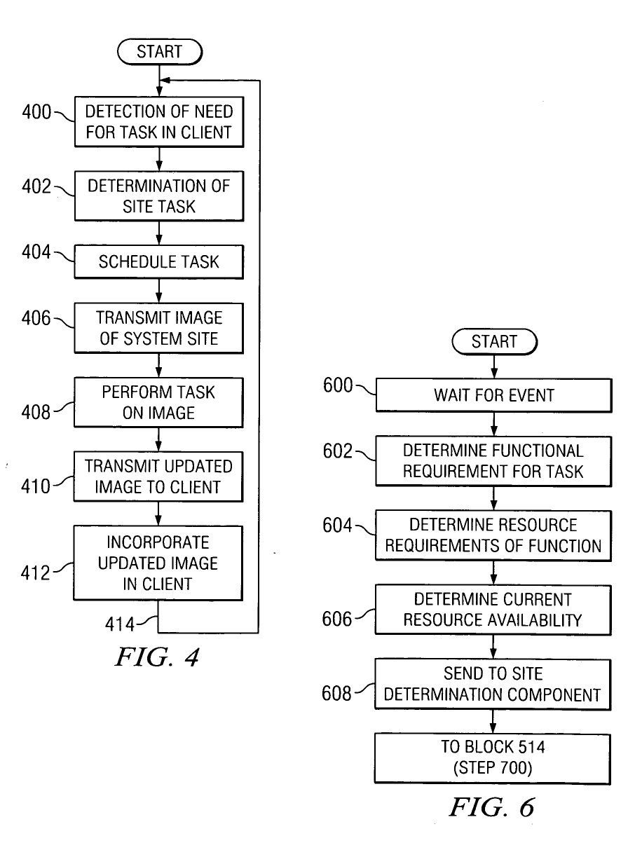

FIG. 4 is a flow chart illustrating a method in accordance with a preferred embodiment of the invention. In general, the method works by copying part or all of an image of a state of a client computer (such as client 108 of FIG. 1) to a second computer system (such as server 104 of FIG. 1) (step 406). The state of the system may be an image of a hard disk, the image of a file, the image of a group of files, the image of a hardware component, the fragmentation status of a hard drive or some other state of a computer system. The second computer system may be maintained by a remote service provider or may be maintained as part of a local area network. After receiving the image, possibly over a network such as network 102 of FIG. 1, the second computer system performs the resource-intensive task (step 408). Thus, the client machine is not slowed down and is not impacted until the service is rendered. When the task has been completed, the resultant updated image of the state of the client's system is transmitted to the client system (step 410). The updated image is then incorporated into the current state of the client's computer system (step 412).

In this example, the method begins with the detection of a need to perform a particular resource-intensive task on a client computer (step 400). Step 400 is performed on the user's system, though it may be performed by a server or service provider that scans the client computer for the presence of a need. The scan may be scheduled, automatically performed or performed upon input from a user.

A task may need to be performed for various reasons. These include timed or repetitive performance of a task, as in weekly backup. Other reasons may include, for example, an explicit request from the user to perform a task, as in backup before traveling. One task may require another task, as in the case in which a file is to be backed up. The file first should be scanned for viruses to avoid backing up an infected file. An outside agent may initiate this type task. For example, anti-virus software may be programmed to request virus removal by a second computer system once a virus has been detected. Regardless of the cause, a program module is notified of the task to be performed. The program module is also provided with information concerning the nature of the task, task priority, and optionally other descriptive data.

Next, a determination is made regarding at which site the task will be performed (step 402). In this example, this step is performed in the depicted example by the program module that was notified in step 400. This module uses information about the current state of the user's system, such as whether the system is in use, the defragmentation status of a disk on the user's system, whether a virus is present on the disk or other possible states, as well as information about which sites and computers can perform the task. The determination regarding where a task will be performed may take into consideration other factors such as the cost of communicating data to and from the site, the historical reliability of the site, an assessment of the security of the site, the current computing load on that site, and other criteria. Each potential site may be contacted to determine a fee to perform data transmission and to perform the task. In this example, the program module computes the cost of a task, taking into consideration the total information available regarding the tasks to be performed and the state of the system. The cost to perform a service may then be considered in deciding at which site the task should be performed.

It may be the case that more than one task is to be performed. In this instance, the same site can perform each task as a way to minimize the transmission of data. Alternatively, there may be advantages to selecting a group of sites to perform multiple tasks because of their individual superiority in performing the individual tasks or because of the ease with which the data can be transmitted among the group. In this case, the selection of sites for the performance of the set of tasks is more complex.

After the task site has been determined, the time the task will be performed is scheduled (step 404). The site may have an available time window during which the task can be performed, or the site may wish to postpone the performance of the task until a time at which the site has more resources. During step 404, any constraints on the time at which a site can perform a task are communicated to the program module so that the constraints can be factored into the calculation of the cost. During this step, the task scheduling may be negotiated between the client and the service provider. Finally, a time for transmission of the data (export or import) should also be computed. In this way, the updated image will be transmitted to the client in time to meet any scheduling constraints.

After the task has been scheduled, the image of the state of the client system is communicated to the service provider (step 406). In some system configurations, this can be as simple as making the location of that data on some shared network device known to the selected site. Even more simply, the selected site is one processor in a shared-memory multiprocessor configuration, where at least one processor is capable of direct access to the device on which the data resides. Conversely, there may be a lengthy delay during the transmission of the data, such as if the client and the service provider computer connect via a satellite link or via certain Internet connections. Regardless, step 406 uses appropriate facilities to copy the data needed to perform the task. These facilities may include a file transfer protocol, reservations of bandwidth on a network link, encryption, and the like.

After the image of the state of the client system has been transmitted to the task site, the task is performed at the scheduled time (step 408). The selected site may perform the task by any method necessary or desired. Thus, the selected site may use specialized or reconfigurable hardware, such as that shown in Secure Hardware Personalization Service, identified by attorney docket number YOR920040519US1, filed ______, Ser. No. ______, which is incorporated by reference. In the case that multiple tasks are to be performed, the sites at which these are to be performed may have been chosen by the program module in the user's system in step 402. If necessary, a service provider may subcontract all or part of the task by transmitting part or all of a task to another computer or service provider. A service provider may decide to subcontract a task if the task is taking too long to perform or is consuming more resources than expected. In any case, after the task is completed the product is an updated image of the state of the client's system.

Once the task is complete, the updated image is communicated to the client's system (step 410). For some tasks, the results may be extremely concise, as in an antivirus scan that finds no infection. For some tasks, the results may be comparable in size to the original data, as in a task that decrypts files. In some cases, the results may be far more voluminous than the original data, as in a decompression task. Regardless, this step is similar to step 406, except that the source of the results is the selected site and the destination is the user's system.

In the final step, the updated image is incorporated into the current state of the client system (step 412). The actions taken on the user's system to accomplish step 412 depend on the task performed. For example, if the task is an antivirus scan and the results indicate that a file is infected, a program module associated with antivirus protection will use the name of the infected file in order to place that file in quarantine or to remove the virus. If the task is to back up files, a program module associated with the backup will use the indication of a successful backup to mark files as successfully backed-up, and optionally when and where the files were backed-up. In another example, the task is to compress a file. In this example, the result is a new file of compressed data and the new file should be stored in the file system of the user's system. If the task is to defragment a hard disk, then the updated image of the client's hard disk is mapped onto the current state of the client's hard disk. In this case, care should be taken not to overwrite files that were created or updated after the original image was transmitted to the task site. Each of these examples shows an updated image of a state of client's computer system incorporated into a current state of the client's computer system. Many other tasks may be performed using the mechanism of the present invention. The process of incorporating an updated image of a state of a client's computer system into a current state of the client's system will vary accordingly.

After incorporating the updated image, in this example, monitoring continues to determine whether a new task needs to be performed on the client computer (branch 414). A fee may be charged to perform the monitoring, which may be performed either by the client computer or by the service provider.

FIG. 5 shows a block diagram of software configuration of components, in accordance with a preferred embodiment of the invention. FIG. 5 shows the relationship of software components running in a computer, such as computer 104 of FIG. 1, used to accomplish the process shown in FIG. 4. Personal computer 500 (which may be client computer 104 in FIG. 1) with attached user interface devices 502 and network interface 504 contains operating system 506, scheduler component 508, event source component 510, and detector software component 512.

The need for a task is indicated through user interface devices 502, as a scheduled event originating in scheduler 508, as an external event received via network interface 504 or as an event originating in operating system 506. In any case, the events are forwarded to detector component 512. Site determination component 514 determines the site at which a task will be performed, task-scheduling component 516 determines when a task will be performed and task supervision component 518 supervises or performs the task. Each of these components are discussed further below.

FIG. 6 is a flow chart of a process used by a detector component, such as the detector component of FIG. 5, in accordance with a preferred embodiment of the invention. The detector component first waits for any event that requires that a task be performed (step 600). When the event occurs, the functional requirements of a task associated with that event are determined (step 602). For example, if the event signals that a new virus has been encountered in the computer network, the appropriate response should be to update antivirus signatures and scan for the presence of that virus.

Subsequently, the resources required to perform the task are identified (step 604). Continuing the above example, the resources needed remove or quarantine the virus are determined. In the case of a specialized virus scan, the resources required are processing cycles, memory, and disk access. Each of these resources can be estimated quantitatively based on historical data in these examples. Subsequently, the current resources available to the computer are determined (step 606). If the computer is performing a disk-intensive operation, then disk access is not readily available to perform the task. Thus, the task should be transferred to another computer provided by the service provider. The information regarding resource availability is then sent to a site determination component, such as component 514 of FIG. 5 (step 608), and the process of arranging and performing the task initiated. Thereafter, monitoring is continued for another event that indicates a task should be performed (return to step 600).

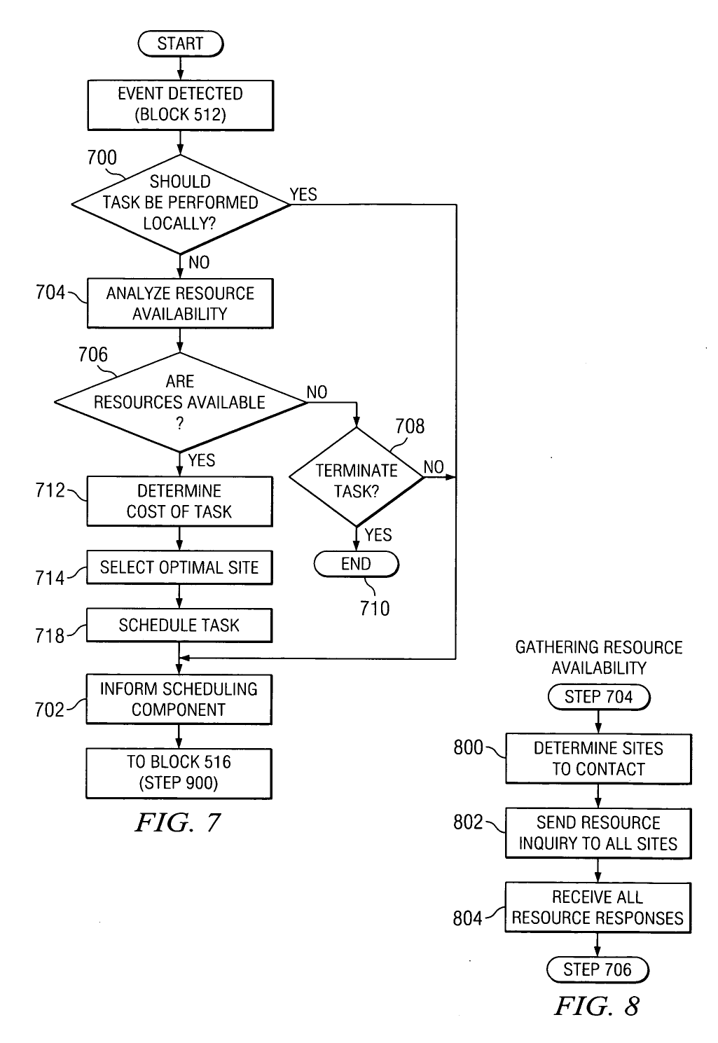

FIG. 7 is a flow chart of a process performed in the site determination component of FIG. 5, in accordance with a preferred embodiment of the invention. (The process of FIG. 7 is performed subsequent to step 608 of FIG. 6 and after the detection component 512 of FIG. 5 has performed its task.) First, the information received from the detection component (block 512) is analyzed to determine if the task should be performed locally (step 700). (If the resource demands on the client computer are light and no new resource demands are anticipated, then the task should be performed locally.) If the task will be performed locally, then the fact that the task will be performed locally is communicated to the task-scheduling component (step 702). (The task-scheduling component is shown in block 516 of FIG. 5 and the process shown in FIG. 6).

If the task should not be performed locally, then the resources available to perform the task are analyzed (step 704). (FIG. 8 shows the steps taken to analyze resource availability.) Step 704 involves determining whether a non-local resource is present and, if so, whether a given non-local resource has the capability of performing the task.

A determination is made as to whether any non-local resources are available (step 706). If not, then the task is performed locally, terminated or performed at another time. Thus, a determination is made, by input from a user or automatically by the operating system or other component, whether a task should be terminated or delayed (step 708). If so, then the task is terminated or delayed (step 710). If not, then the fact that the task will be performed locally is communicated to the scheduling component (step 702).

Returning to the decision of step 706, if at least one non-local task site is available, then the cost for performing the task at each available non-local site is calculated (step 712). One method of determining the cost to perform a task may be a weighted sum involving the cost of communicating the data to the site, the cost of performing the task at the site, the cost of communicating the updated image back to the client, and other factors that can affect cost. (Cost may be evaluated in terms of dollars or in terms of resources available to a computer or an entire system.)

Based on the cost to perform the task and resource availability, an optimal site is selected for performing the task (step 714). The process of determining whether a site is optimal may be based on the resources available to perform the task, the cost to perform the task, history of reliability, preferences due to organizational considerations, security considerations, distance between client and server, the available bandwidth for data transmission, the current task load of a server site, the existence of specialized software or hardware, and possibly many other considerations.

Once the optimal non-local site has been selected, a time for performing the task is scheduled (step 718) by the non-local resource. Once the task has been scheduled, the scheduling component is informed about which non-local site will perform the task and the time the task will be performed (step 702).

FIG. 8 is a flow chart of a process performed during the analyze resource availability step of FIG. 7, in accordance with a preferred embodiment of the invention. Thus, FIG. 8 is a part of the site determination step of step 402 of FIG. 4 and the site determination component 514 of FIG. 5. To analyze resource availability, first, a set of available sites is determined (step 800). The set of available sites may be determined with a predetermined list of sites. However, a plurality of sites may be contacted to determine if a particular site is available. The set of available sites is then the list of available sites. Alternatively, a broker site can be contacted. The broker site broadcasts a message to all potential sites, with the potential sites returning a signal indicating whether a particular task site is available. The broker site accumulates the list of available sites and provides that list to the client.

Once the set of available sites has been determined, an inquiry is made to each site regarding the available resources at each site (step 802). The resource inquiry message may include the resource needs to process the given function. The step of determining available sites and the step of sending a resource inquiry may be combined. Similarly, a broker site can perform both steps.

Next, the client or the broker site waits for responses to be returned from the set of available sites. The response from the inquiry may include resource availability by type of resource, the cost of a task, a list of available time slots and other information. After all responses have arrived, or after a predetermined time has elapsed, the responses are captured and made available for subsequent processing (step 804). If the broker site accumulated the responses, then the broker makes the information (regarding available sites) available to the client. A task site is then selected (step 402 of FIG. 4) from the set of sites and the task scheduled (step 404 of FIG. 4) at the selected site.

If multiple tasks are required, then each task may be distributed to multiple task sites or performed on the same site. Similarly, a very large task, depending on the nature of the task, could be distributed among multiple task sites. The decision to use multiple task sites depends on a variety of factors, such as the time required to transmit data, specialization of task sites, the ease of transmission of data between sites, the ease of returning data to the client, and the relative costs associated with performing different tasks or with splitting a task. This decision may also depend on a number of other factors that relate to the speed, timing, and cost of performing a task or a set of tasks.

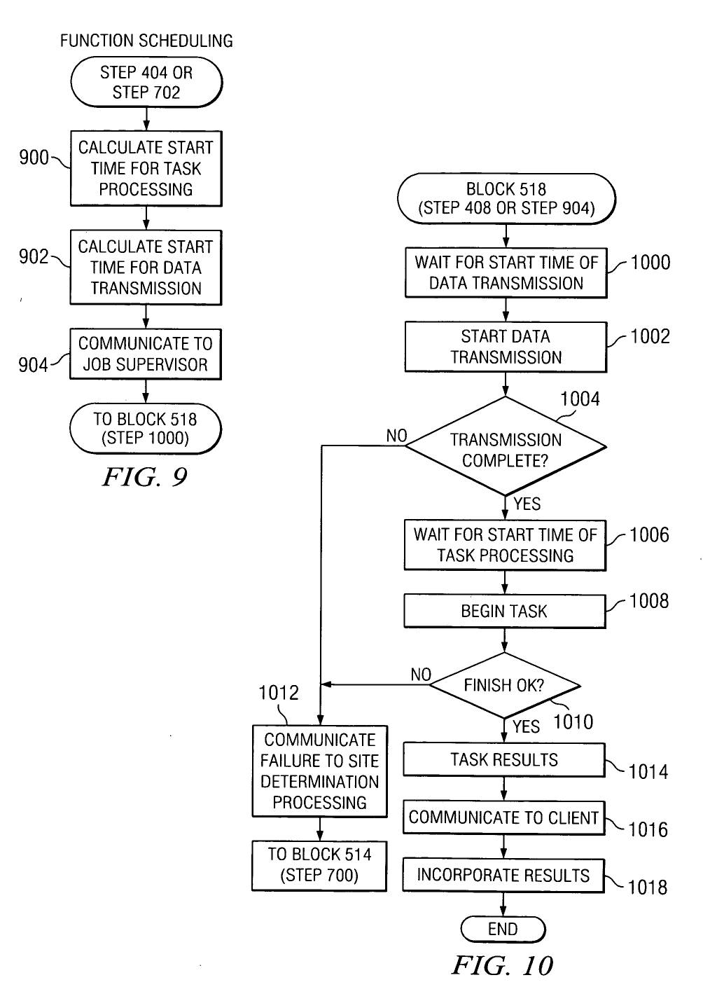

FIG. 9 is a flow chart of a process performed in the task-scheduling component of FIG. 5, in accordance with a preferred embodiment of the invention. Thus, FIG. 9 is also part of the schedule task step 404 of FIG. 4. First, the start time for task processing is calculated (step 900). In most cases, this will be the start of the scheduled time received as a response from the selected site (step 804 of FIG. 8). Thereafter, the start time for data transmission is calculated (step 902). This time is calculated, in these examples, based on an estimate of the bandwidth of the computer network connecting the client computer and the selected site, the start time of task processing, and the size of the data to be transmitted. The start time is adjusted based on the completion of data transmission. Some tasks randomly access data, in which case transmission is fully complete before the task can begin. Other functions process data sequentially, so the task can begin while data is still being received or during a delay in data transmission. Once the start times for task processing (step 900) and data transmission (step 902) have been calculated, both start times are communicated to the task supervisor component (block 518 of FIG. 5).

FIG. 10 is a flow chart of a process performed in the task supervisor component of FIG. 5, in accordance with a preferred embodiment of the invention. The process of FIG. 10 is performed during step 408 of FIG. 4 and after step 904 of FIG. 9. First, the server waits for the start time of data transmission to the selected site (step 1000). At the scheduled time, data transmission begins (step 1002). Assuming that all of the data needs to be transmitted before beginning a task, an acknowledgement from the client is used to determine whether data transmission is complete (step 1004). If not, then the failure to communicate the data within a particular time is communicated (step 1012) to the site determination component (block 514 of FIG. 5) and the process of site determination (step 700 of FIG. 7) is begun again. If data transmission is complete, then the server waits for the scheduled time to begin the task (step 1006). (In the case where a task can begin during data transmission, step 1004 may be skipped. However, if a failure in data transmission occurs, the failure should be communicated to the site determination component, as described above.)

When the time to perform the task begins, the selected site starts the task (step 1008). A monitor then monitors whether the task has been completed within the scheduled time (step 1010). If not, then the failure to communicate the task is communicated to the site determination component, as described above with regard to the failure to transmit data (step 1012). Alternatively, the server can re-evaluate the time required to complete the task, the cost, and the task completed. In this example, client input is required to complete the task if the cost increases. Similarly, if the task was not performed successfully, then the failure to perform successfully is communicated to the site determination component (step 1012). Again, the server can instead re-evaluate the task, determine the need for additional tasks, and complete all tasks automatically, automatically subcontract additional tasks, or complete or subcontract tasks based on user input. If the task is successfully performed, then the results of the task are stored (step 1014). The task results may be communicated directly to the client as new data becomes available.

The results of the completed task are communicated to the client (step 1016) and then incorporated into the current state of the client computer system (step 1018). (Steps 1016 and 1018 correspond to steps 410 and 412 of FIG. 4). Thus, the client computer may have a necessary task completed without having to consume much of the client computer's resources.

Thus, the present invention provides a method of transferring part of all of an image of a system or disk to another computer dedicated to performing a resource-intensive task, such as search tasks, security tasks, maintenance tasks or any other resource-intensive tasks. Once the dedicated computer has performed the task, the resulting image is compared to the current image of the client system or disk. The two images are integrated or synchronized to produce an updated image. The client system or disk is then updated with the updated image.

The present invention is advantageous over prior methods of performing resource-intensive tasks on a client system because the present invention offloads the resource intensive-tasks to second computer system. Thus, the client's computer system is available to perform other needed tasks.

It is important to note that while the present invention has been described in the context of a fully tasking data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for performing a task in a data processing system, the method comprising:
transferring portions of an image of the data processing system to a remote data processing system;
performing the task using the portions of the image transferred to the remote data processing system to form updated portions of the image; and
returning the updated portions of the image back to the data processing system, wherein the resources of the data processing system are not required to perform the task.

2. The method of claim 1, wherein the returning step comprises:
transferring the updated portions of the image to the data processing system; and
incorporating the updated portions of the image back into the image at the data processing system.

3. The method of claim 1, wherein the portions of the image are all of the image on the data processing system.

4. The method of claim 1, wherein the state is the fragmentation status of a hard drive of the first computer system and wherein the task is degfragmenting the image of the hard drive.

5. The method of claim 1, wherein the portions of the image are a file stored in a computer readable medium, and wherein the task is selected from the group consisting of encrypting the file, decrypting the file, compressing the file, decompressing the file, scanning the file for a virus and backing up the file.

6. The method of claim 1, wherein the portions of the image are a memory system of the computer system and the task is selected from the group consisting of scanning the memory system for the presence of a virus, cleaning the memory system of a virus present on the memory system, quarantining a virus present on the memory system, scanning the memory system for the presence of adware, scanning the memory system for the presence of spyware, scanning the memory system of a particular file, scanning the memory system for a particular text, deleting adware present on the memory system, deleting spyware present on the memory system, deleting a file present on the memory system, modifying a file on the memory system, indexing files contained on the memory system, compressing files contained on the memory system, decompressing files contained on the memory system, encrypting files contained on the memory system, decrypting files contained on the memory system and backing up files contained on the memory system.

7. A method of performing a task on a first state of a first computer system, said method comprising the steps of:
copying an image of the first state of the first computer system to a second computer system;
performing the task on the image using the second computer system, thereby producing an updated image of the state of the first computer system;
transferring the updated image to the first computer system; and
incorporating the updated image into a current state of the first computer system.

8. The method of claim 7, wherein the state is the fragmentation status of a hard drive of the first computer system and wherein the task is degfragmenting the image of the hard drive.

9. The method of claim 7, wherein the state is a file stored in a computer readable medium, and wherein the task is selected from the group consisting of encrypting the file, decrypting the file, compressing the file, decompressing the file, scanning the file for a virus and backing up the file.

10. The method of claim 7, wherein the state is a memory system of the computer system and the task is selected from the group consisting of scanning the memory system for the presence of a virus, cleaning the memory system of a virus present on the memory system, quarantining a virus present on the memory system, scanning the memory system for the presence of adware, scanning the memory system for the presence of spyware, scanning the memory system of a particular file, scanning the memory system for a particular text, deleting adware present on the memory system, deleting spyware present on the memory system, deleting a file present on the memory system, modifying a file on the memory system, indexing files contained on the memory system, compressing files contained on the memory system, decompressing files contained on the memory system, encrypting files contained on the memory system, decrypting files contained on the memory system and backing up files contained on the memory system.

11. The method of claim 7, wherein the second computer system is owned by a service provider and the step of performing the task is performed by the service provider, and wherein the method further comprises paying a fee to the service provider for performing the task, wherein the task is selected from the group consisting of copying the image to the second computer system, scheduling the first task to be performed at a particular time, performing the task, performing a second task, performing a second task on the image before copying the second image to the first computer system and incorporating the second image into the current image.

12. The method of claim 7, further comprising the steps of:
before transferring the image to the second computer system, analyzing the state of the first computer system; and
determining whether the task needs to be performed on the state of the first computer system.

13. The method of claim 12, wherein the step of analyzing and determining is made by a service provider and wherein the service provider provides a notice to a user of the first computer system, said notice recommending that a set of tasks be performed on the state of the first computer system.

14. A computer program in a computer readable medium, said medium contained in a system selected from one of a first computer system, a second computer system and a combination thereof, and wherein said program is designed to carry out the steps of:
copying an image of a first state of the first computer system to the a second computer system;
performing the task on the image using the second computer system, thereby producing an updated image of the state of the first computer system;
transferring the updated image to the first computer system; and
incorporating the updated image into a current state of the first computer system.

15. The computer program of claim 14, wherein the second computer system is owned by a service provider and the step of performing the task is performed by the service provider, and wherein the program further comprises charging a fee for performing the task, wherein the task is selected from the group consisting of copying the image to the second computer system, scheduling the first task to be performed at a particular time, performing the task, performing a second task, performing a second task on the image before copying the second image to the first computer system and incorporating the second image into the current image.

16. The computer program of claim 14, wherein the program is further designed to carry out the steps of:
before transferring the image to the second computer system, analyzing the state of the first computer system; and
determining whether the task needs to be performed on the state of the first computer system.

17. The computer program of claim 16, wherein the step of analyzing and determining is made by a service provider and wherein the program is further designed to charge a fee for making the determination.

18. The computer program of claim 16, wherein the step of analyzing and determining is made by a service provider and wherein the computer program is further designed to provide a notice to a user of the first computer system, said notice recommending that a set of tasks be performed on the state of the first computer system.

19. A computer system comprising:
a bus;
a memory operably connected to the bus;
a processor operably connected to the bus;
wherein the processor contains instructions to perform the steps of:
copying an image of a first state of a first computer system to a second computer system;
performing a task on the image using the second computer system, thereby producing an updated image of the state of the first computer system;
transferring the updated image to the first computer system; and
incorporating the updated image into a current state of the first computer system.

20. The computer system of claim 19, wherein the processor contains additional instructions for performing the steps of:
before transferring the image to the second computer system, analyzing the state of the first computer system; and
determining whether the task needs to be performed on the state of the first computer system.

21. The computer system of claim 20, wherein the processor contains additional instructions to charge a fee for making the determination.

22. The computer system of claim 20, wherein the processor contains further instructions designed to provide a notice to a user of the first computer system, said notice recommending that a set of tasks be performed on the state of the first computer system.

23. The computer system of claim 22, wherein the processor contains additional instructions for performing the task based on input from the user.
